(19) United States
(12) Patent Application Publication
(10) Pub. No.: US 2021/0231191 A1
(43) Pub. Date: Jul. 29, 2021

(54) PLATE LINK CHAIN

(71) Applicant: Schaeffler Technologies AG & Co. KG, Herzogenaurach (DE)

(72) Inventor: Carsten Trautmann, Rastatt (DE)

(73) Assignee: Schaeffler Technologies AG & Co. KG, Herzogenaurach (DE)

(21) Appl. No.: 15/734,797

(22) PCT Filed: May 14, 2019
(86) PCT No.: PCT/DE2019/100434

§ 371 Date: Dec. 3, 2020

(30) Foreign Application Priority Data
Jun. 8, 2018 (DE) 10 2018 113 750.8

(51) Int. Cl. F16G 5/18; F16G 13/08

(52) U.S. Cl. CPC F16G 5/18; F16G 13/08

(57) ABSTRACT

A plate link chain for a continuously variable cone pulley belt transmission of a motor vehicle includes a plurality of cradle thrust pieces arranged in joints, a plurality of link plates coupled by the joints, and a contact device disposed between a pair of the joints. The contact device includes a contact surface arranged to contact a pulley surface. In an example embodiment, the contact device is arranged in a free space of the plate link chain facing towards the pulley surface. In an example embodiment the contact device is attached to a one of the plurality of link plates. In an example embodiment, the plate link chain includes a frame, and the contact device is attached to the frame. In an example embodiment, the contact surface is convexly curved. In an example embodiment, the contact surface is elastic relative to the pulley surface.

### CROSS-REFERENCE TO RELATED APPLICATIONS

This application is the United States National Phase of PCT Appln. No. PCT/DE2019/100434 filed May 14, 2019, which claims priority to German Application No. DE102018113750.8 filed Jun. 8, 2018, the entire disclosures of which are incorporated by reference herein.

### TECHNICAL FIELD

The disclosure relates to a plate link chain, in particular for a continuously variable cone pulley belt transmission of a motor vehicle, with link plates which are coupled in joints by cradle thrust pieces.

### BACKGROUND

From the published German patent application DE 100 47 979 A1, a plate link chain for a continuously variable transmission of a motor vehicle is known, which has at least one securing element and several chain links which are articulately connected to one another via hinge devices. The chain links each have several link plates each with at least one through opening, and the hinge devices have cradle pieces which extend essentially perpendicular to the running direction of the plate link chain. The cradle pieces extend through a plurality of through openings of different plates, which are partially assigned to a first chain link and partially to a second chain link. At least one cradle piece has a recess, the at least one securing element at least limits the mobility of at least one cradle piece with respect to at least one link plate in the direction of the longitudinal axis of the cradle piece, and the at least one securing element extends into at least one recess of at least one cradle piece.

From the German patent application DE 101 10 896 A1, a plate link chain is known for a continuously variable cone pulley belt transmission for a motor vehicle, consisting of link plates and joint pieces connecting the link plates, with securing elements attached at least to individual joint pieces by means of resistance welding.

The international published application WO 2014/173410 A2 discloses a method for welding securing elements to thrust pieces of a plate link chain using electrodes. Two electrodes are applied simultaneously to the same thrust piece when welding at least two securing elements to a thrust piece.

### SUMMARY

The disclosure provides a plate link chain, e.g., for a continuously variable cone pulley belt transmission of a motor vehicle, with link plates which are coupled in joints by cradle thrust pieces with regard to their acoustic properties during operation, for example.

A plate link chain, e.g., for a continuously variable cone pulley belt transmission of a motor vehicle, with link plates which are coupled in joints by means of cradle thrust pieces, includes at least one contact device having at least one contact surface facing towards a pulley surface arranged between the joints, which contact surface comes into contact with the pulley surface. Securing elements such as are known, for example, from the German patent application DE 101 10 896 A1 can be attached to the cradle thrust pieces. The known securing elements serve to prevent the cradle thrust pieces from undesirably migrating out of the link plates. In contrast to the known securing elements, the contact device must constitute an additional contact between the plate link chain and the pulley surface. As a result, a shorter pulse sequence can be implemented when the plate link chain is in operation, which has a positive effect on the acoustic properties of the plate link chain during operation.

At least one contact device is provided between all the joints of the plate link chain. Depending on the design of the plate link chain, however, contact devices can also be arranged only between individual joints of the plate link chain. The pulley surface is formed on a pulley of a pulley set of a cone pulley belt transmission equipped with the plate link chain. A pulley set of such a cone pulley belt transmission usually includes two cone pulley pairs which are connected to one another by the plate link chain.

In an exemplary embodiment of the plate link chain, the contact device is arranged in a free space of the plate link chain facing towards the pulley surface. With conventional plate link chains, there are construction-related free spaces. The free spaces result from the fact that the cradle thrust piece pairs, which serve to represent the cradle joints, protrude transversely to a chain running direction past the link plates of the plate link chain. The protrusion of the cradle thrust piece pairs prevents undesirable migration or slippage of the link plates when the plate link chain is in operation. In an example embodiment, the design-related free spaces in the plate link chain are used to accommodate the contact devices. Corresponding contact devices may be arranged in all construction-related free spaces that are present over the circumference of the plate link chain.

In another exemplary embodiment of the plate link chain, the contact device is attached to a link plate of the plate link chain. The contact device may be attached to the link plate of the plate link chain, for example, with a material fit and/or a form fit. The contact device may be connected elastically to the link plate of the plate link chain. However, the contact device itself can also be designed to be elastic. An elastic connection of the contact device to the link plate can then be omitted.

In another embodiment of the plate link chain, the contact device is attached to an additional frame. The supposed disadvantage of an additional component is consciously accepted. The additional frame can, at least partially, be made to be elastic.

In another exemplary embodiment of the plate link chain, the frame engages two joints of the plate link chain which are adjacent in the chain running direction. The frame may be designed in the same way or similar to a link plate of the link plate link chain that engages two adjacent joints of the link plate link chain.

In another embodiment of the plate link chain, the frame engages the link plates transversely to the chain running direction of the plate link chain. The frame engages all the link plates of the plate link chain transversely to the chain running direction. The frame has, for example, essentially the shape of a rectangle that engages all the link plates of the plate link chain transversely to the chain running direction.

In another embodiment of the plate link chain, the contact surface facing the pulley surface is convexly curved. The convex design can be in the radial and/or circumferential direction. The curvature of the contact surface facing the pulley surface is designed so that the contact device comes into contact with the respective pulley surface as gently as possible. This prevents undesired damage to the contact device and/or to the pulley surface. The contact surface facing the pulley surface can be round in plan view. However, the contact surface facing the pulley surface can also have the shape of an ellipse in plan view. The contact surface can also be provided with an angle, comparable with conventional cradle thrust pieces. The angle is adapted to that of the pulley set.

In another embodiment of the plate link chain, the contact surface is elastic relative to the pulley surface. The contact surface is connected elastically to the plate link chain, e.g., to the link plates of the plate link chain. However, the contact surface can also be designed to be elastic itself. The elastic design of the contact surface or the elastic connection of the contact surface to the plate link chain ensures, among other things, that forces are not necessarily transmitted via the contact device or the contact devices between the pulley sets during operation of the plate link chain.

In another exemplary embodiment of the plate link chain, the contact device includes at least one contact element and at least one elastic element. The elastic element can be designed, for example, as a spring device. However, the elastic element can also be formed from an elastic plastic material. The contact element is formed from a metallic material.

The disclosure further relates to a contact device, e.g., to a contact element, an elastic element and/or a frame, for a plate link chain described above. The parts mentioned can be dealt with separately.

The disclosure optionally also relates to a cone pulley belt transmission with a plate link chain described above. The cone pulley belt transmission may be a so-called CVT transmission. In the CVT transmission, the plate link chain is used to drivingly connect two sets of cone pulleys to one another. CVT stands for continuously variable transmission and means that the ratio of the CVT transmission is continuously variable. The plate link chain is at least partially surrounded by a lubricating medium, such as oil, in the cone pulley belt transmission.

### BRIEF DESCRIPTION OF THE DRAWINGS

Further advantages, features and details of the disclosure emerge from the following description, in which various exemplary embodiments are described in detail with reference to the drawing. In the figures:

FIG. 1 shows a schematic representation of a conventional plate link chain;

FIG. 2 shows a plate link chain similar to that in FIG. 1, wherein a contact device is arranged in a design-related free space;

FIG. 3 shows an enlarged representation of a detail III from FIG. 2;

FIG. 4 shows a plate link chain similar to that in FIGS. 2 and 3 in a plan view of a contact device;

FIG. 5 shows a plate link chain similar to that in FIG. 2 with a contact device which is attached to a frame which engages two joints of the plate link chain which are adjacent in the chain running direction;

FIG. 6 shows an enlarged detail VI from FIG. 5;

FIG. 7 shows the plate link chain from FIG. 6 with the contact device in a plan view;

FIG. 8 shows a representation similar to that in FIG. 2 with an alternative contact device;

FIG. 9 shows an enlarged detail IX from FIG. 8;

FIG. 10 shows the plate link chain from FIG. 9 with the contact device in a plan view;

FIG. 11 shows a plate link chain similar to that in FIG. 2 with an alternative contact device;

FIG. 12 shows an enlarged detail XII from FIG. 11;

FIG. 13 shows the plate link chain from FIG. 12 with the contact device in a plan view;

FIG. 14 shows a plate link chain similar to that in FIG. 2 with a contact device which is attached to a frame which engages the link plates transversely to the running direction of the plate link chain;

FIG. 15 shows an enlarged detail XV from FIG. 14; and

FIG. 16 shows the plate link chain from FIG. 15 with the contact device in a plan view.

### DETAILED DESCRIPTION

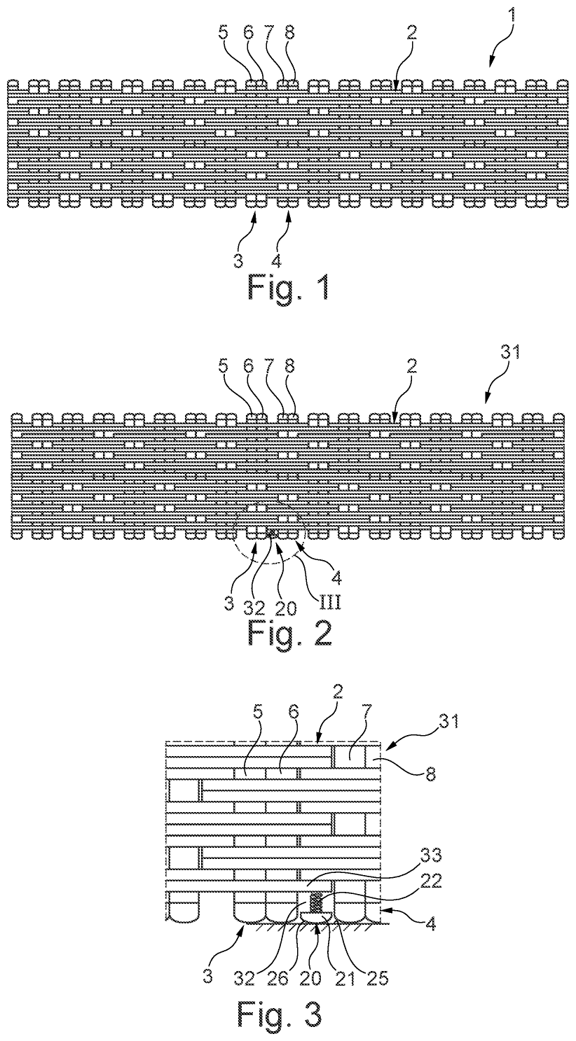

In FIG. 1, a conventional plate link chain 1 with a plurality of link plates 2 is shown in simplified form. The link plates 2 of the link plate link chain 1 are coupled to one another in a known manner by joints 3, 4. The plate link chain 1 is designed, for example, like the plate link chain shown in FIG. 1 of the German patent application DE 101 10 896 A1.

The cradle thrust pieces 5 to 8 are used to represent the joints 3, 4. The cradle thrust pieces 5, 6 are combined in a cradle thrust piece pair, which is used to represent the joint 3. The cradle thrust pieces 7, 8 are combined in a cradle thrust piece pair, which is used to represent the joint 4. The joints 3, 4 are also referred to as cradle joints.

In FIG. 2, a plate link chain 31 according to the disclosure is shown in the same manner as in FIG. 1. A contact device 20 is arranged in the plate link chain 31 in a design-related free space 32 of the plate link chain 31. As can be seen in the enlarged view of detail III from FIG. 2 in FIG. 3, a contact device 20 includes a contact element 21 and an elastic element 22.

The elastic element 22 is designed as a spring device and is attached to a link plate 33 which delimits the free space 32 between the cradle thrust pieces 6 and 7. The contact element 21 is made of metal, for example, and has a contact surface 26. The contact surface 26 is convexly curved. With the contact surface 26, the contact element 21 of the contact device 20 rests against a pulley surface 25, shown in simplified form, of a cone pulley, not further shown, of a cone pulley pair of a pulley set of a cone pulley belt transmission.

By means of the elastic element 22, the contact device 20 with the contact element 21 is pretensioned against the pulley surface 25. The elastic pretensioning ensures that the contact element 21 remains in contact with the pulley surface 25 during operation of the plate link chain 31. The pretensioning force of the elastic element 22 may be selected such that no forces are transmitted from the pulley surface 25 via the contact device 20 to the plate link chain 31.

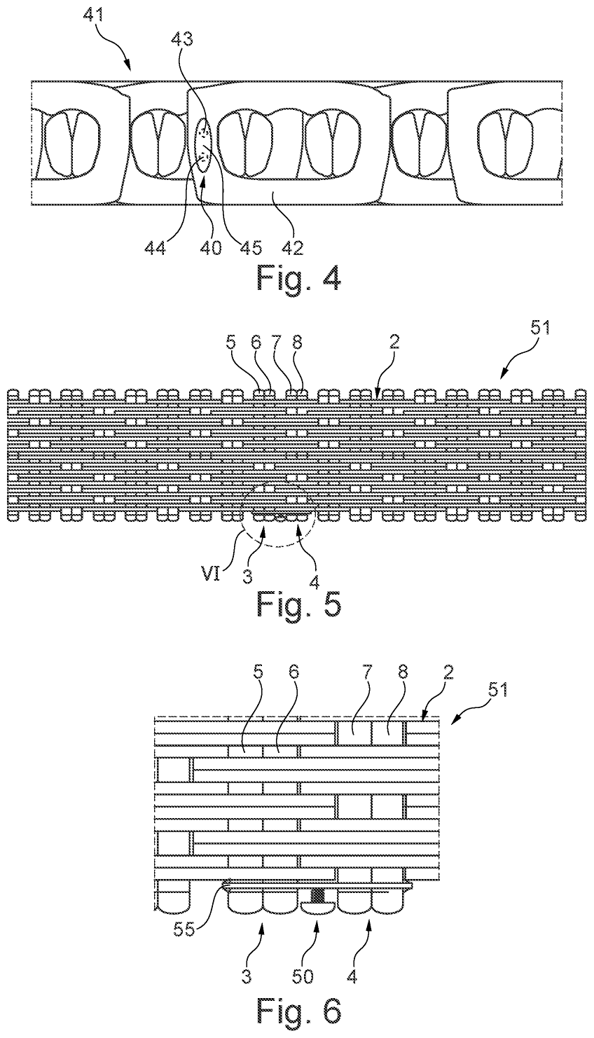

In FIG. 4, a plate link chain 41 is shown in plan view. The plate link chain 41 can correspond to the plate link chain 31 in FIG. 2. A contact device 40 is attached to a link plate 42 of the plate link chain 41. The contact device 40 includes two elastic elements 43, 44, only indicated, which are designed as springs, for example. A common contact element 45 of the contact device 40 is attached to the two elastic elements 43, 44. The contact element 45 has the shape of an ellipse in the plan view shown in FIG. 4.

FIGS. 5 to 7 show a plate link chain 51 with a contact device 50. The contact device 50, for example, is the same as or similar to the contact device 20 in FIGS. 2 and 3 or 40 in FIG. 4. In contrast to the previous exemplary embodiment, the contact device 50 is not attached to a link plate of the plate link chain 51, but rather to a frame 55.

As can be seen in FIGS. 6 and 7, the frame 55 engages the two joints 3, 4 of the plate link chain 51 which are adjacent in the chain running direction. The frame 55 has essentially the same shape as one of the link plates 2 of the link plate link chain 51. Depending on the design, the frame 55 can be designed to be at least partially elastic in order to ensure that the plate link chain 5 functions properly.

In FIG. 7 it can be seen that the essentially rectangular frame 55 includes a central web 56 to which the contact device 50 is attached. The two spring devices or elastic elements 43, 44 to which the contact element 45 is attached are used, for example, to fasten the contact device 50 to the central web 56.

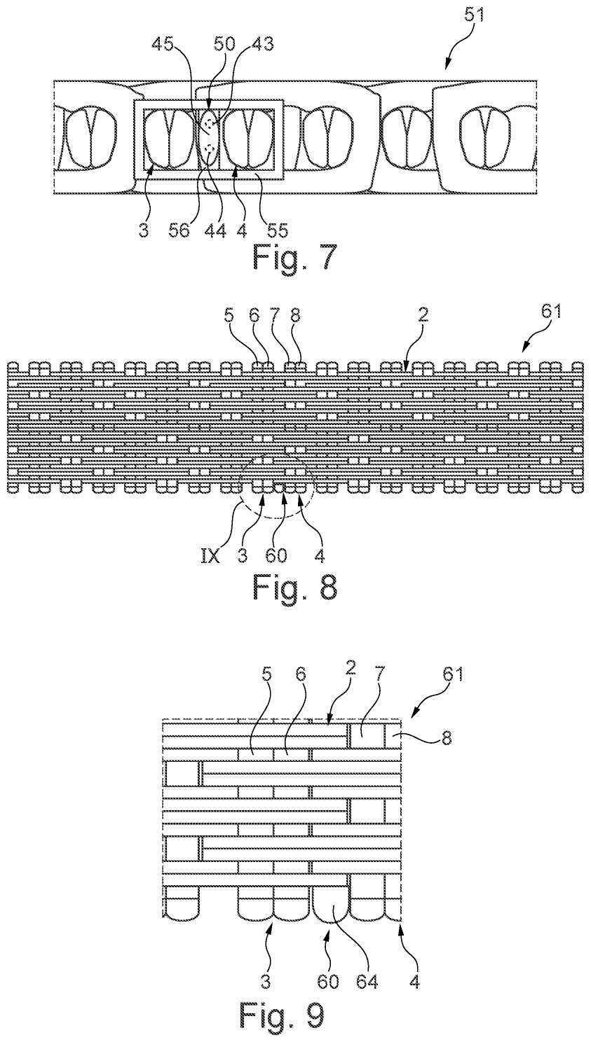

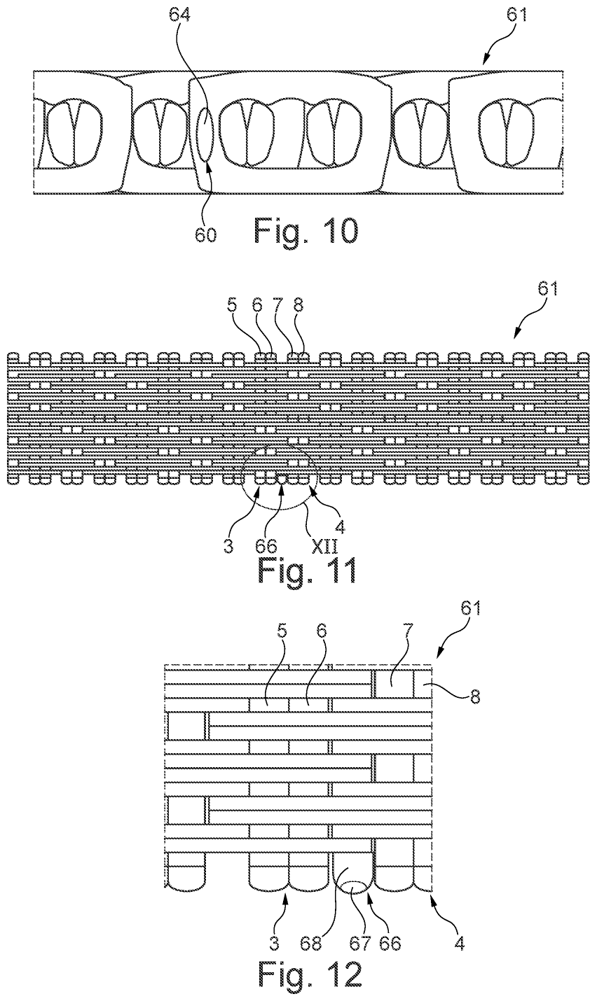

In FIGS. 8 to 10, a plate link chain 61 with a contact device 60 is shown. The contact device 60 comprises only a single contact element 64. The contact element 64 is made, for example, from a suitable plastic material to represent the desired elasticity or elastic connection. Otherwise, the contact device 60 is designed and arranged in the same way as, for example, the contact device 20 in FIGS. 2 and 3.

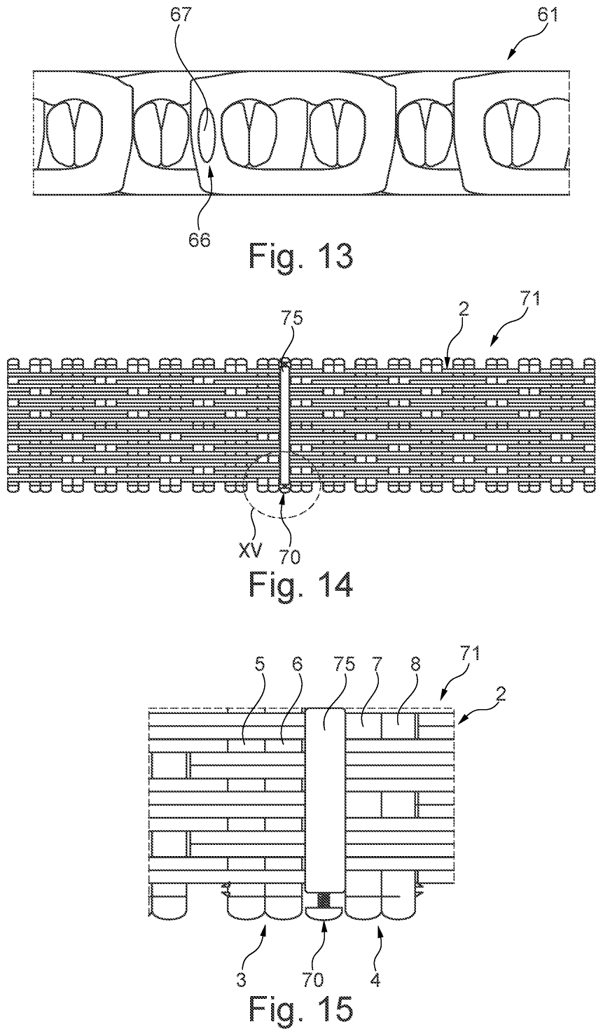

In FIGS. 11 to 13 it is indicated that the contact device (60 in FIGS. 8 to 10) of the plate link chain 61 can also be designed as a two-part contact device 66. The contact device 66 includes a metallic contact element 67 which is attached to an elastic element 68. The elastic element 68 is, for example, like the contact element 64 in FIGS. 9 to 11, formed from a suitable plastic material. In contrast to this, the contact element 67 is formed from a metallic material. This prevents undesirable wear when the contact device 66 comes into contact with the pulley surface.

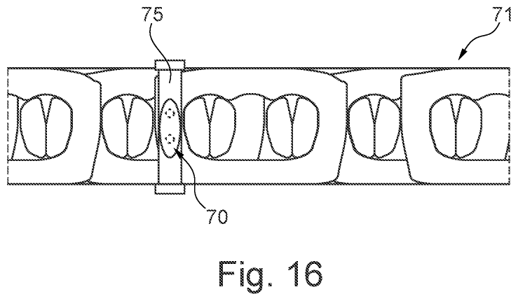

In FIGS. 14 to 16 it is shown that a contact device 70, which for example corresponds to the contact device 20 in FIGS. 2, 3 or the contact device 40 in FIG. 4, can also be attached to an alternative frame 75. The frame 75 engages all the link plates 2 of the plate link chain 71 transversely to the chain running direction. The contact device 70 may be attached to the frame 75, for example, with a material fit and/or a form fit.

The same reference signs are used in FIGS. 1 to 16 to designate the same or similar parts. To avoid repetition, only or mainly the differences between the plate link chains 1; 31; 41; 51; 61; 71 are described.

All contact devices 20; 40; 50; 60; 66; 70 have in common that they are each arranged in the design-related free space 32 of the respective plate link chain. In the installed state, all free spaces in the plate link chain may be equipped with a contact device. In this way, a much shorter pulse sequence with positive acoustic properties can be achieved in a simple manner during operation of the plate link chain.

The contact devices 20; 40; 50; 60; 66; 70 should not necessarily transfer forces between the pulley sets, but rather only bring about an additional impact on the pulley. In order to ensure that the pulley is touched, but that no high forces are then absorbed, the contact elements 21; 45; 67 may be elastically connected to the plate link chain 1; 31; 41; 51; 61; 71.

Due to the rather low forces during operation, the wear on the contact devices 20; 40; 50; 60; 66; 70 can be kept low during operation of the plate link chain. The contact devices 20; 40; 50; 60; 66; 70 can also be introduced in conventional plate link chains 1; 31; 41; 51; 61; 71, since the existing free spaces can be used for receiving the contact devices 20; 40; 50; 60; 66; 70.

### REFERENCE NUMERALS

1 Plate link chain

2 Link plates

3 Joint

4 Joint

5 Cradle thrust piece

6 Cradle thrust piece

7 Cradle thrust piece

8 Cradle thrust piece

20 Contact device

21 Contact element

22 Elastic element

25 Pulley surface

26 Contact surface

31 Plate link chain

32 Free space

33 Link plate

40 Contact device

41 Plate link chain

42 Link plate

43 Elastic element

44 Elastic element

45 Contact element

50 Contact device

51 Plate link chain

55 Frame

56 Central web

60 Contact device

61 Plate link chain

64 Contact element

66 Contact device

67 Contact element

68 Elastic element

70 Contact device

71 Plate link chain

1.-10. (canceled)

11. A plate link chain for a continuously variable cone pulley belt transmission of a motor vehicle, comprising:
a plurality of cradle thrust pieces arranged in joints;
a plurality of link plates coupled by the joints; and
a contact device, disposed between a pair of the joints, comprising:
a contact surface arranged to contact a pulley surface.

12. The plate link chain of claim 11, wherein the contact device is arranged in a free space of the plate link chain facing towards the pulley surface.

13. The plate link chain of claim 11, wherein the contact device is attached to a one of the plurality of link plates.

14. The plate link chain of claim 11, further comprising a frame, wherein the contact device is attached to the frame.

15. The plate link chain of claim 14, wherein the frame engages two joints which are adjacent in a running direction of the plate link chain.

16. The plate link chain of claim 14, wherein the frame engages the plurality of link plates transversely to a running direction of the plate link chain.

17. The plate link chain of claim 11, wherein the contact surface is convexly curved.

18. The plate link chain of claim 11, wherein the contact surface is elastic relative to the pulley surface.

19. The plate link chain of claim 11, wherein the contact device comprises:
a contact element; and
an elastic element.
